(19) United States
(12) Patent Application Publication
(10) Pub. No.: US 2008/0216879 A1
(43) Pub. Date: Sep. 11, 2008

(54) Sanitizer cleaning system for shopping carts

(76) Inventor: Ryan Casey Johnson, Rogers, AR (US)

Correspondence Address: Ryan Johnson, 1011 Little Flock Dr, Rogers, AR, 72756, US

(21) Appl. No.: 12/072,896

(22) Filed: Feb. 28, 2008

Related U.S. Application Data
(60) Provisional application No. 60/904,258, filed on Mar. 1, 2007.

(51) Int. Cl. B08B 3/00

(52) U.S. Cl. 134/198

(57) ABSTRACT

A self-contained, fogging/atomizing sanitizer cleaning system for multiple grocery/shopping carts is manufactured and retro-fit for any size room which is used to hold shopping/grocery carts before they are distributed to consumers for use in retail stores. A stationary pumping station has a direct drive stainless steel high-pressure pump, a control panel with start stop controls, an adjustable timer, a solenoid pressure release valve, a high-pressure cut-off switch, and sanitizer storage tank. The pumping station is operatively connected to stainless steel tubing, fog/atomizing nozzle lines, stainless steel extenders, and anti-drip atomizing nozzles spray jet heads which are mounted to two walls of a preexisting cart holding room or coral with mounting hardware/channel clamps (either inside or outside the retailer). This systems kit provides the retailer the ability to fill the shopping cart holding room (either indoor or outdoor) with stacked together shopping carts and automatically based on a timer, sanitize multiple shopping/grocery carts at once in a matter of seconds.

### CROSS REFERENCE TO RELATED APPLICATIONS

This application claims benefit of provisional application Ser. No. U.S. 60/904,258 filed Mar. 1, 2007.

### STATEMENT REGARDING FEDERALLY SPONSORED RESEARCH OR DEVELOPMENT

Not applicable

### BACKGROUND OF THE INVENTION

1. Field of the Invention

The present invention relates to a self-contained, fogging/atomizing sanitizer cleaning system for multiple grocery/shopping carts and in particular to such a system which can be retro fitted for any size room, which is used to hold shopping carts before they are distributed to consumers.

2. Brief Description of Related Art

Supermarkets, grocery stores and the like provide grocery carts for customer's convenience. The carts are adapted to hold the customer's selected purchases. The carts thus contain food, including liquids, which in time are spilled or come in contact with the cart surfaces. Also many customers have small children who are carried in the carts. Not only is it unsanitary to continue to use dirty, unsanitized carts but in time such use could promote the spreading of disease as microorganisms will multiply where food items have been left and humans have spread germs, microorganisms, illnesses, etc. . . .

Since it is good sanitation practice to have the carts cleaned after every use, a definite need exists for a system, which will sanitize ordinary shopping carts in a short period of time, and in bulk to not interfere with the normal distribution of shopping carts to consumers.

The standard wire rod or mesh basket grocery cart is provided with a handle, a basket mounted in a frame, and generally four caster mounted wheels. The carts vary greatly in design, however, they all present a basket to allow the purchaser to move their selected items and in most cases they provide a seat and pivoting support for the seat for the carrying of infants and small children.

As previously mentioned, due to the nature of the produce and raw meats hauled in the carts and the gradual accumulation of filth upon the carts it is highly desirable that the carts be cleaned after every use. Failure to thoroughly clean such carts could reduce the level of customers to a particular store since customers prefer not to use unsanitary, soiled carts. On the other hand, if the grocery carts were sanitized after every use the food outlet store could advertise such a fact, which would greatly enhance the trade at that outlet.

The standard practice at most stores which utilize shopping carts is to clean the carts manually by the use of high pressure steam or hot water wands and then to have the detergent and hot water rinsed away by the use of a fresh water spray.

Unfortunately, manual washing of carts is inefficient so that it costs far too much per cart to clean the carts. It also leaves a mess in the parking lot. It is not uncommon for large supermarkets to have 1000 or more carts in their establishment; so inefficient manual washing of so many carts is too costly. The grocery store owner may be forced to increase the interval between washing cycles and thus deprive his customers of the clean, sanitary carts that they desire. Also, simply washing the carts and not actually sanitizing does not provide the level of cleanliness to kill the germs, micro bacteria, and pathogens that spread illness and disease. Also, by dispersing the sanitizer in a fogging/atomized way the sanitizer is more able to penetrate into the tight areas of the cart and kill as many germs as possible.

It is desirable to provide for a complete cleaning and sanitizing system employing the atomization of sanitizer and a self contained system which can be retro fitted to any size room for holding shopping carts. Such an invention would greatly reduce the costs of sanitizing grocery carts, thus allowing the storeowners to have the carts sanitized at a more frequent interval, and provide the level of sanitation to prevent the spread of illness and disease.

Accordingly, a need exists for a self-contained, fogging/atomizing sanitizer cleaning system for multiple grocery/shopping carts. Such a system would provide a simple, inexpensive apparatus that could sanitize multiple carts in a matter of seconds, return the cart to service with complete confidence of customers in its cleanliness. A cleaning system of that type would provide a system that is simple in design, easy to maintain, and easy to adjust to different types of grocery carts as well as different sizes of shopping cart holding rooms/corals. Such a device should be easily repaired, not subject to damage by proper use and simple to manufacture. The instant invention is directed to all of these needs as well as to others as explained in the following description.

### DESCRIPTION OF THE INVENTION

The primary purpose of the invention is to provide a self-contained, fogging/atomizing sanitizer cleaning system for multiple grocery/shopping carts, easily adapted to a number of designs of grocery carts and cart holding rooms, and provides that when the operator has finished sanitizing the carts no evidence of sanitizing fluid is left as residue. The device is self-contained in that multiple grocery carts can be moved into the sanitizing room and exited in a complete sanitized state without the necessity for employing additional stations or process steps.

The purposes and features of the invention are obtained by providing systems kit equipped with high pressure atomizing spray jets retro-fit for any size room used for holding shopping carts and having the fog/atomizing jet head lines attached to a self contained pumping station skid which whereby holds all necessary pumps and electrical to achieve atomization of the sanitizer. The pumping station also consists of a storage tank, which holds the sanitizer. The grocery carts are moved into the retrofit holding room just as before the room was equipped with the sanitizing system. Once the room is full of carts or even if it is desired to sanitize only a few carts the “start” button is pressed and the room is filled with the atomized sanitizer and the entire group of carts is sanitized in a matter of seconds.

In an embodiment of the present invention as shown in the accompanying drawings, a self-contained, fogging/atomizing sanitizer cleaning system for multiple grocery/shopping carts is provided in which a systems kit is manufactured and retro-fit for any size room which is used to hold shopping/grocery carts before they are distributed to consumers for use in retail stores. This systems kit consists of a stationary (either wall mounted or floor set) pumping station which consists of a 1000+ PSI direct drive stainless steel high pressure pump, a control panel with start stop, an adjustable timer, a solenoid pressure release valve, a high pressure cut-off switch, and a 30-60 gallon sanitizer storage tank. This systems kit is also equipped with stainless steel tubing, fog/atomizing nozzle lines, stainless steel extenders, and anti-drip atomizing nozzles spray jet headers. These stainless steel tubing and pre-equipped fog/atomizing nozzle lines with spray jet nozzles are mounted to 2 walls of the pre-existing grocery/shopping cart holding room and then connected to the pumping station. This kit also is equipped with set mounting hardware—channel clamps—for mounting the stainless steel tubing and fog/atomizing lines to the walls. This systems kit provides the retailer the ability to fill the shopping cart holding room (either indoor or outdoor) with stacked together shopping carts and sanitize multiple shopping/grocery carts at once in a matter of seconds.

Although specific applications, materials, components, sequences of events, and methods have been stated in the above description of the preferred embodiment of the invention, other suitable materials, other applications, components and process steps as listed herein may be used with satisfactory results and varying degrees of quality. In addition, it will be understood that various other changes in details, materials, steps, arrangements of parts and uses which have been herein described and illustrated in order to explain the nature of the invention will occur to and may be made by those skilled in the art, upon a reading of this disclosure, and such changes are intended to be included within the principles and scope of this invention as hereinafter claimed.

Insofar as the description above and the accompanying drawings disclose any additional subject matter that is not within the scope of the single claim below, the inventions are not dedicated to the public and the right to file one or more applications to claim such additional inventions is reserved.

Although a very narrow claim is presented herein, it should be recognized that the scope of this invention is much broader than presented by the claim. It is intended that broader claims will be submitted in one or more applications that claim the benefit of priority from this application.

The present invention has been described with reference to certain preferred and alternative embodiments that are intended to be exemplary only and not limiting to the full scope of the present invention.

### DESCRIPTION OF DRAWINGS

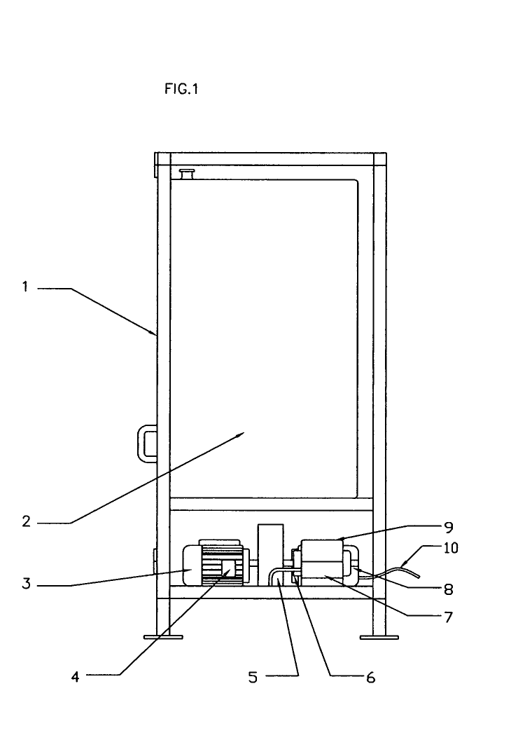

FIG. 1 (the pumping station)
1) Locking storage cabinet
2) 30-60 gallon sanitizer reservoir
3) 1000+ PSI direct drive stainless steel high pressure pump
4) Solenoid pressure release valve
5) Control panel
6) Start stop manual switch
7) Adjustable timer
8) High pressure cut off switch
9) Air compressor
10) 110 electrical power cord

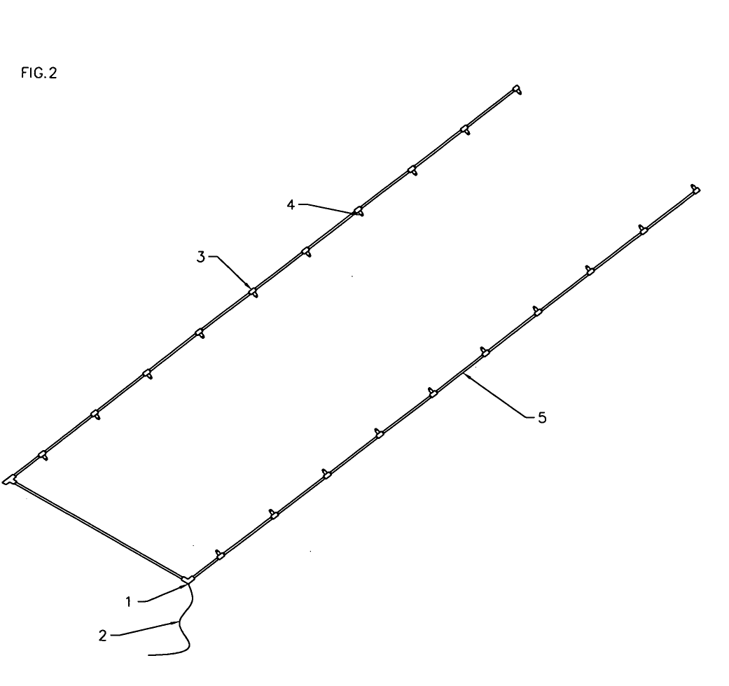

FIG. 2 (stainless steel tubing, fog/atomizing nozzle lines)
1) Stainless steel 90 degree corner brackets
2) Flexible stainless steel threaded hose/tubing
3) Stainless steel T-bracket
4) Atomizing spray jet headers
5) ¼ inch, interior diameter, stainless steel tubing

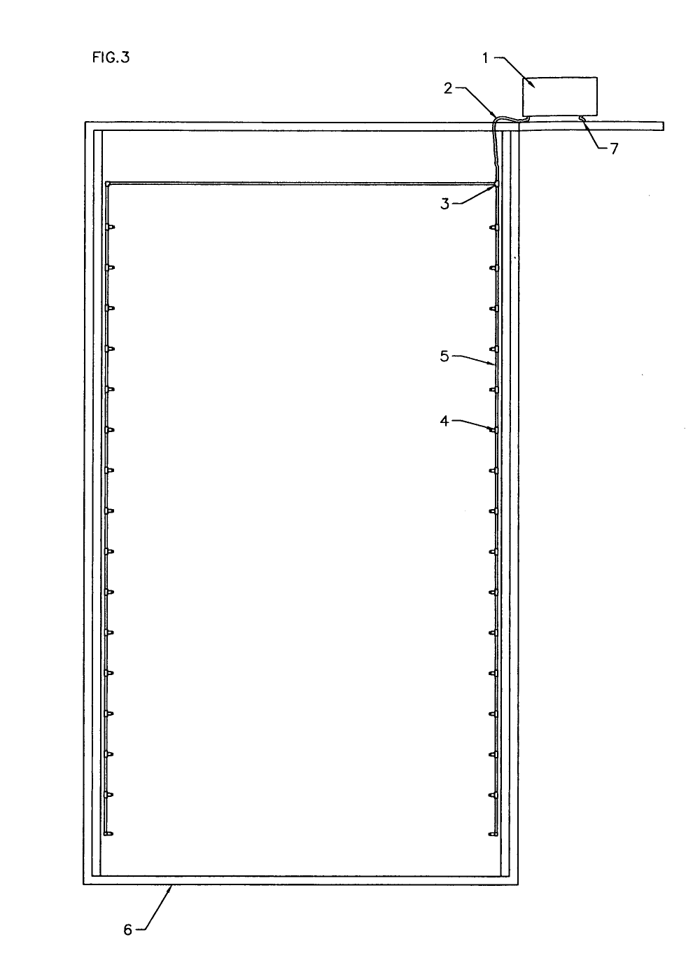

FIG. 3 (the entire system as installed in a retailer's shopping cart holding room)
1) The pumping station (see FIG. 1)
2) Flexible stainless steel threaded hose/tubing
3) Stainless steel 90 degree corner brackets
4) Stainless steel t-bracket with attached atomizing spray jet headers
5) ¼ inch, interior diameter, stainless steel tubing
6) Pre-existing retailer shopping cart holding room (size may vary)
7) 110 electrical power cord

What is claimed is:

1-10. (canceled)

11. I claim a system for sanitizing a shopping cart, comprising: a fluid delivery source for providing a fluid; a plurality of atomizing spray nozzles for receiving said fluid and ejecting said fluid, said plurality of nozzles being positioned in multiple sets of a plurality of nozzles, where each set the plurality of nozzles is directed to provide said fluid to completely cover the entire area of a pre-existing retail store shopping cart hold room were shopping carts are stacked together and made readily available for customers as said customers enter said retailer; a pumping station delivering said fluid to the plurality of nozzles at high pressure to ensure extremely fine atomization of said fluid and said pumping station set to activate on a timer so that said fluid is delivered to said plurality of nozzles on a regular bases to ensure that all shopping carts are completely sanitized before every customer use of said shopping carts.

12. A system according to claim 1, wherein said fluid is of a bio-based sanitizing fluid

13. A system according to claim 2, wherein said fluid is a disinfecting agent for neutralizing the harmful affects of contaminants that reside on shopping carts
